(19) United States
(12) Patent Application Publication
(10) Pub. No.: US 2015/0304640 A1
(43) Pub. Date: Oct. 22, 2015

(54) Managing 3D Edge Effects On Autostereoscopic Displays

(71) Applicant: DOLBY ALBORATORIES LICENSING CORPORATION, San Francisco, CA (US)

(72) Inventor: David BROOKS, Mountain View, CA (US)

(73) Assignee: DOLBY LABORATORIES LICENSING CORPORATION, San Francisco, CA (US)

(21) Appl. No.: 14/653,365

(22) PCT Filed: Dec. 17, 2013
(86) PCT No.: PCT/US2013/075832

§ 371 Date: Jun. 18, 2015

Related U.S. Application Data
(60) Provisional application No. 61/740,435, filed on Dec. 20, 2012.

(51) Int. Cl. H04N 13/04; H04N 13/00

(52) U.S. Cl. CPC H04N 13/0404; H04N 13/0409; H04N 13/0438; H04N 13/0011; H04N 13/0018; H04N 13/0022; H04N 2013/0074; H04N 2013/0081

(57) ABSTRACT

3D images may be represented by a sequence of received pairs of LE and RE frames. It is determined whether a frame comprising a floating window exists in a pair of LE and RE frames in the sequence of pairs of LE and RE frames. If so, depth information for one or more pixels in a plurality of pixels in a portion of the frame covered by the floating window is determined. Such depth information may be generated based on depth information extracted from one or more frames in one or more pairs of LE and RE frames in the sequence of pairs of LE and RE frames that are either previous or subsequent to the pair of LE and RE frames.

### CROSS-REFERENCE TO RELATED APPLICATIONS

This application claims priority to U.S. Provisional Patent Application No. 61/740,435 filed 20 Dec. 2012, which is hereby incorporated by reference in its entirety.

### TECHNOLOGY

The present invention relates generally to 3-dimensional (3D) display techniques, and in particular, to managing 3D edge effects in 3D display systems.

### BACKGROUND

In general, human eyes perceive 3D images based on the slight (parallactic) disparity of the left eye (LE) view and the right eye (RE) view by, for example: anaglyph filtering, linear polarization separation, circular polarization separation, shutter glasses separation, spectral separation filtering, lenticular lens separation, parallax barrier screening, etc. The illusion of depth can be created by providing an (image) frame as taken by a left camera in a stereo camera system to the left eye and a slightly different (image) frame as taken by a right camera in the stereo camera system to the right eye.

In a sequence of 3D images, which are formed by presenting respective pairs of LE and RE frames to viewers, an object in front of a screen plane in the 3D images may move out toward, or move in from, an edge of the screen plane. Sometimes, in a portion of the sequence of 3D images, a part of the object in front of the screen plane is cropped off by the edge of the screen plane, which is supposed to be behind the object as indicated by the visible part of the object. A viewer's brain cannot reconcile properly between two conflicting concurrent perceptions, one of which perceives the object as being located in front of the screen plane while the other of which perceives the object as being behind the screen plane based on the fact that the object is partially visually obstructed by the screen plane. This gives the viewer an impression that the 3D images are incorrect and unnatural, and is known as edge violation. This is a significant problem to 3D viewing experience as in the real world it should not be physically possible for something behind to visually obstruct an object in the front. Accordingly, as illustrated in FIG. 2A, a floating window comprising a black line or a black bar may be inserted in a released version of 3D images in one or the other frame in a pair of LE and RE frames to cause the viewer to see an object that is partially cropped off by an edge of a screen plane only from one of the LE and RE perspectives. The loss of depth information due to the presence of the floating window causes the object to be perceived as being located at the screen plane rather than in front of the screen plane, thereby avoiding or ameliorating uncomfortable psychological effects that may be produced by an edge violation. The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF DRAWINGS

The present invention is illustrated by way of example, and not by way of limitation, in the figures of the accompanying drawings and in which like reference numerals refer to similar elements and in which:

FIG. 1A and FIG. 1B illustrate example sequences of 3D images as represented by sequences of respective pairs of LE and RE frames along a media time direction;

FIG. 2A illustrates an example floating window in a pair of LE and RE frames that form a 3D image;

FIG. 2B illustrates an example depth mapping;

FIG. 3 illustrates example generation of a plurality of frames corresponding to a pair of LE and RE frames;

FIG. 4A and FIG. 4B illustrate example sequences of 3D images;

FIG. 5A and FIG. 5B illustrate example process flows for reconstructing depth information for pixels in floating windows;

FIG. 6 illustrates an example of motion analysis on a series of image frames;

FIG. 7A and FIG. 7B illustrate example 3D system configurations;

FIG. 8 illustrates an example processes flow; and

FIG. 9 illustrates an example hardware platform on which a computer or a computing device as described herein may be implemented.

### DESCRIPTION OF EXAMPLE POSSIBLE EMBODIMENTS

Example possible embodiments, which relate to managing 3D edge effects in 3D display systems, are described herein. In the following description, for the purposes of explanation, numerous specific details are set forth in order to provide a thorough understanding of the present invention. It will be apparent, however, that the present invention may be practiced without these specific details. In other instances, well-known structures and devices are not described in exhaustive detail, in order to avoid unnecessarily occluding, obscuring, or obfuscating the present invention.

Example embodiments are described herein according to the following outline:
1. GENERAL OVERVIEW
2. STRUCTURE OVERVIEW
3. DEPTH MAPPING
4. DETERMINING DEPTH INFORMATION BASED ON TEMPORAL INFORMATION
5. MOTION ESTIMATION
6. EXAMPLE SYSTEM CONFIGURATIONS
7. PROCESS FLOWS
8. IMPLEMENTATION MECHANISMS—HARDWARE OVERVIEW
9. EQUIVALENTS, EXTENSIONS, ALTERNATIVES AND MISCELLANEOUS

### 1. GENERAL OVERVIEW

This overview presents a basic description of some aspects of a possible embodiment of the present invention. It should be noted that this overview is not an extensive or exhaustive summary of aspects of the possible embodiment. Moreover, it should be noted that this overview is not intended to be understood as identifying any particularly significant aspects or elements of the possible embodiment, nor as delineating any scope of the possible embodiment in particular, nor the invention in general. This overview merely presents some concepts that relate to the example possible embodiment in a condensed and simplified format, and should be understood as merely a conceptual prelude to a more detailed description of example possible embodiments that follows below.

A display system may receive a released version of a video program, a movie, etc., comprising 3D images in the form of pairs of LE and RE frames. Without the presence of a floating window, most if not all pixels in an LE frame of a pair of LE and RE frames have correspondence relationships with pixels in an RE frame in the same pair. Disparity information or (spatial) differences between one or more pixels in the LE frame and one or more corresponding pixels in the RE frame may be used to present to a viewer the depths of objects or visual features portrayed by these pixels in the pair of LE and RE frames that form a 3D image.

3D images produce edge violations if an object or visual feature that transits in or out of the 3D images as portrayed in the 3D images are located at a depth that does not match that of the screen plane of the display system. The presence of a floating window to blacken out the part containing the object or visual feature in one frame in a pair of LE and RE frames avoids or ameliorates the edge violation but causes the loss of per pixel or per pixel block depth information for pixels that are affected by the floating window. Some pixels in the other frame of the same pair of LE and RE frames, whether portraying the object or visual feature or not, no longer have corresponding pixels in the frame in which the floating window is present, since the original corresponding pixels in the frame in which the floating window is present are now replaced by black pixels or undefined pixel values. Thus, depth information for these pixels is lost.

The loss of partial depth information due to the presence of a floating window may cause relatively significant problems to certain 3D display applications and 3D display systems that do not render the 3D image by directly and merely displaying the LE and RE frames (e.g., in a frame-sequential manner, etc.) with incomplete disparity information as received in the released version of 3D images. In order to render visually correct 3D images, these 3D display applications and 3D display systems may need to determine depth information for some or all of the pixels that are now covered by the floating window.

An example of such a display system is a multi-view display system configured to generate a different set of frames with different perspectives for each pair of LE and RE frames received. In some embodiments, the multi-view display system is a 3D autostereoscopic display system with an optical stack such as lenticular lens separation, parallax barrier screening, etc. The multi-view display system may need to constrain the depth volume of 3D content to be rendered therewith. The limited depth volume of the 3D display system and the need for the 3D display system to generate a different set of frames corresponding to each received pair of LE and RE frames may require (1) compressing the higher volume of original 3D content and/or performing other related linear or non-linear spatial transformations of a portrayed scene, (2) performing interpolating, extrapolating, volumetric mappings or depth mappings that require determining per pixel or per pixel block depth information, etc.

Another example of a display system that needs to determine depth information for some or all of the pixels that are now covered by the floating window in order to render visually correct 3D images is a 3D display system such as a handheld device, a home theater, etc., which still renders a LE frame and a RE frame for the respective LE and RE perspectives but has a different depth volume—which may be correlated with, e.g., viewing distances, screen sizes, etc.—than the depth volume of a received pair of LE and RE frame. The display system may need to display two or more LE and RE views which are different from a received pair of LE and RE frames. The different depth volume of the display system and the need for the display system to generate different LE and RE views require (1) compressing or expanding the depth volume of original 3D content and/or performing other related linear or non-linear spatial transformations of a portrayed scene, and (2) performing volumetric mappings or depth mappings that require determining per pixel or per pixel block depth information, etc.

Techniques as described herein may be used to determine depth information for a sequence of 3D images. The sequence of 3D images comprises one or more 3D images in which floating windows are used to blacken or block out a dismembered object in one of LE and RE perspectives. The sequence of 3D images may comprise one or more scenes. In some embodiments, disparity information in a current image pair or a current pair of LE and RE frames may be used to derive depth information for individual pixels or individual pixel blocks of the current image pair or the current pair of LE and RE frames. It should be noted that disparity information in a pair of LE and RE frames as described herein may use either negative or positive parallax convention for the purpose of the invention. In some embodiments, relative to a current image pair or a current pair of LE and RE frames, one or more previous and/or subsequent pairs of LE and RE frames and/or depth information derived therefrom may be buffered. When it is detected that the current image pair or the current pair of LE and RE frames contains a floating window, depth information derived from the previous and/or subsequent pairs of LE and RE frames can be used to complement the depth information derived from the current image pair or the current pair of LE and RE frames.

Techniques as described herein may be implemented on the video encoder side, the video decoder side, etc. The video decoder receives/decodes, from a video file, a video signal, etc., a sequence of pairs of LE and RE frames some of which contain floating windows. Techniques as described herein may be used to generate complete or substantially complete depth information for some or all the pairs of LE and RE frames in the sequence including those pairs of LE and RE frames that contain the floating windows. The depth information may be used by the video decoder and/or by a display system containing or operating in conjunction with the video decoder to perform one or more operations including those that require determining the depth information for pixels that are affected by floating windows.

In some embodiments, depth information for a 3D image or a corresponding pair of LE and RE frames may be represented with a depth map. In some embodiments, such a depth map may cover an area that is the same as, or alternatively exceeds, the area of a corresponding pair of LE and RE frames as decoded or constructed from the released version of 3D images. The extra depth map information may be used to reduce artifacts, as well as concealment thereof, both at one or more edges of a screen plane and where floating windows are used.

In some embodiments, techniques as described herein are implemented in a manner that does not affect the display operations of existing/legacy 3D receivers, as these techniques do not require necessarily altering LE frames or RE frames (which may still contain floating windows) that are sent to a 3D display system, whether such a 3D display uses (additional) depth information generated for the LE frames or RE frames or not.

In some embodiments, encoder-generated depth maps may be streamed separately in video bit streams or layers to recipient devices.

In some embodiments, mechanisms as described herein form a part of a video encoder, a video decoder, an art studio system, a cinema system, a display system, a handheld device, tablet computer, theater system, outdoor display, game machine, television, laptop computer, netbook computer, cellular radiotelephone, electronic book reader, point of sale terminal, desktop computer, computer workstation, computer kiosk, PDA and various other kinds of terminals and display units, etc.

Various modifications to the preferred embodiments and the generic principles and features described herein will be readily apparent to those skilled in the art. Thus, the disclosure is not intended to be limited to the embodiments shown, but is to be accorded the widest scope consistent with the principles and features described herein.

### 2. STRUCTURE OVERVIEW

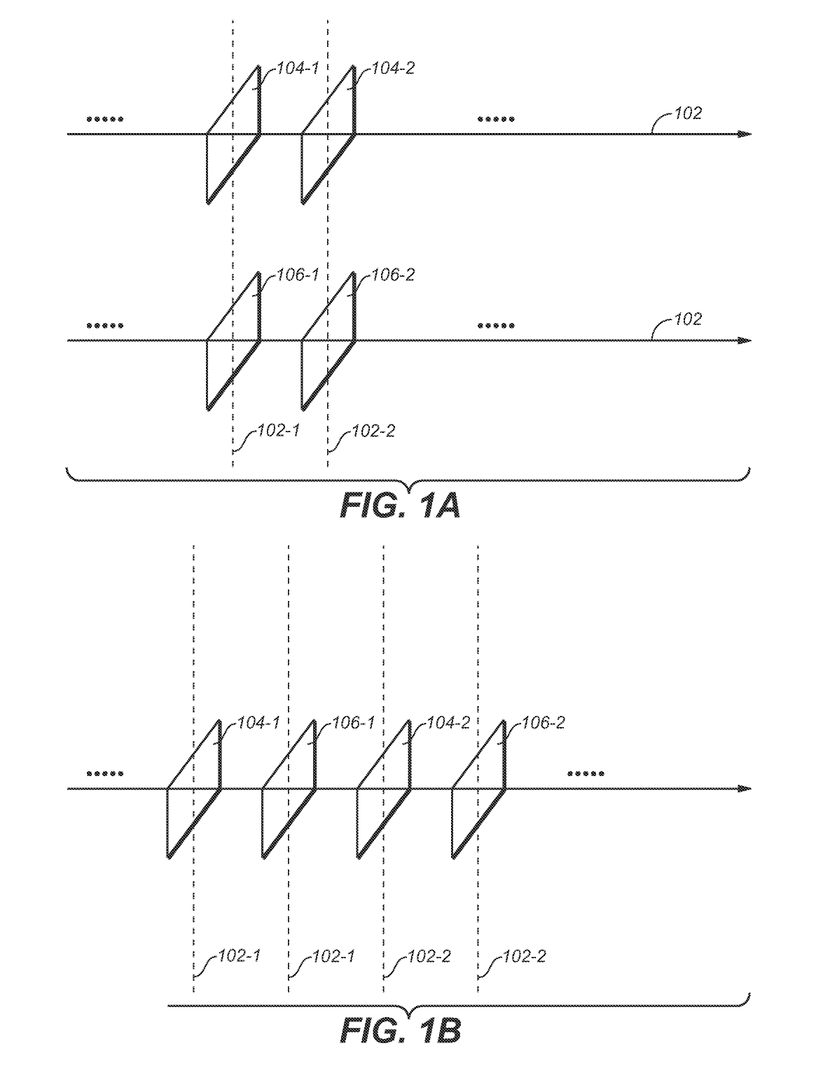

FIG. 1A illustrates example frame data that comprises a sequence of LE frames (e.g., 104-1, 104-2, etc.) along a media time direction 102 and a sequence of RE frames (e.g., 106-1, 106-2, etc.) along the same media time direction 102. As used herein, the term “media time” may refer to a media time point in a sequence of media time points that make up the total playing time of the image data. For example, if the image data represents a movie, a media time of the image data may be a media time point in the sequence of media time points that make up the two-hour playing time of the movie. While the image data may be played, paused, stopped, rewound, and fast-forwarded arbitrarily in real time, the total playing time, or the sequence of media time points, of the image data is an intrinsic property of the image data. As illustrated in FIG. 1A, the sequence of media time points comprises a plurality of media time points (e.g., 102-1, 102-2, etc.) along a media time direction such as 102. As used herein, the term “media time direction” refers to the particular direction along which the sequences of frames in the image data are to be normally played by a media player.

In some possible embodiments, each second of normal playing time of the image data may comprise 24 media time points (e.g., 102-1, 102-2, etc.). In some other embodiments, each second of the normal playing time may comprise a different number of media time points corresponding to one of a variety of different frame rates (e.g., 48 fps, 60 fps, 72 fps, 120 fps, etc.). At each media time point along the media time direction 102, there are (1) a LE frame from the sequence of LE frames, and (2) a corresponding RE frame from the sequence of RE frames, respectively for the left and right eyes at that media time point. For example, as illustrated, at media time point 102-1, there are two frames: LE frame 104-1 and RE frame 106-1 in the image data.

In some possible embodiments as illustrated in FIG. 1B, the sequence of LE frames and the sequence of RE frames may be provided in a single overall sequence of frames. A 3D display system as described herein is configured to determine (e.g., decode, etc.), based on the image data, any individual LE frame or RE frame (e.g., 104-1, 106-1, etc.) therein. It should be noted that a sequence of LE frames and RE frames as described herein refers to a logical sequence of LE frames and RE frames in the playback order as decoded from encoded image data in an input signal. The encoded image data may comprise predicted frames as predicted by one or more later frames. Thus, encoded image data for frame 106-2 may be used to predict frame 106-1, so frame 106-2 may actually come first in the encoded image data in the input signal.

### 3. DEPTH MAPPING

In some embodiments, 3D images as described herein may be provided in a release version (e.g., a 3D Blu-ray version, etc.) of 3D content. In some embodiments, the release version is derived or adapted from a master version (e.g., a cinema version, etc.) of the same 3D content. LE and RE images decoded from the release version may be directly rendered.

3D images as rendered with received LE and RE images in the release version can have a depth range from a very short distance (e.g., 5 inches, etc.) to a very long distance (e.g., infinity, 30 feet, etc.). Either positive or negative parallax convention may be used to represent pixel disparity. Maximum disparity or spatial distance (e.g., 2.5 inches, etc.) between corresponding pixels as represented in a received pair of LE and RE frames may be larger than that supported by a recipient 3D display system. A recipient display system such as a 3D autostereoscopic display system can have a relatively small depth range (e.g., 30 inches in total, etc.). The limited depth volume may be due to optics used in the 3D display system (e.g., how light is bent in by lenticular lenses in the 3D autostereoscopic display system, etc.). Depth mapping may be used to map—e.g., based on one or more of math functions, conversion laws, lookup tables, piecewise transformations, etc.—original depth information derived from (e.g., disparity information, etc.) a received pair of LE and RE frames to new depth information in a set of new frames to drive 3D display operations of a recipient 3D display system. In some embodiments, a 3D display system may be configured to set a depth range or a depth volume based on a user input command (e.g., from a remote control, a knob control, etc.).

In some embodiments, additionally and/or optionally, an original screen plane may be mapped to a new screen plan by a recipient 3D display system. For example, the screen depth at a theater may be improper as the screen depth of a recipient 3D display system. In some embodiments, a 3D display system may be configured to set a screen depth based on a user input command (e.g., from a remote control, a knob control, etc.).

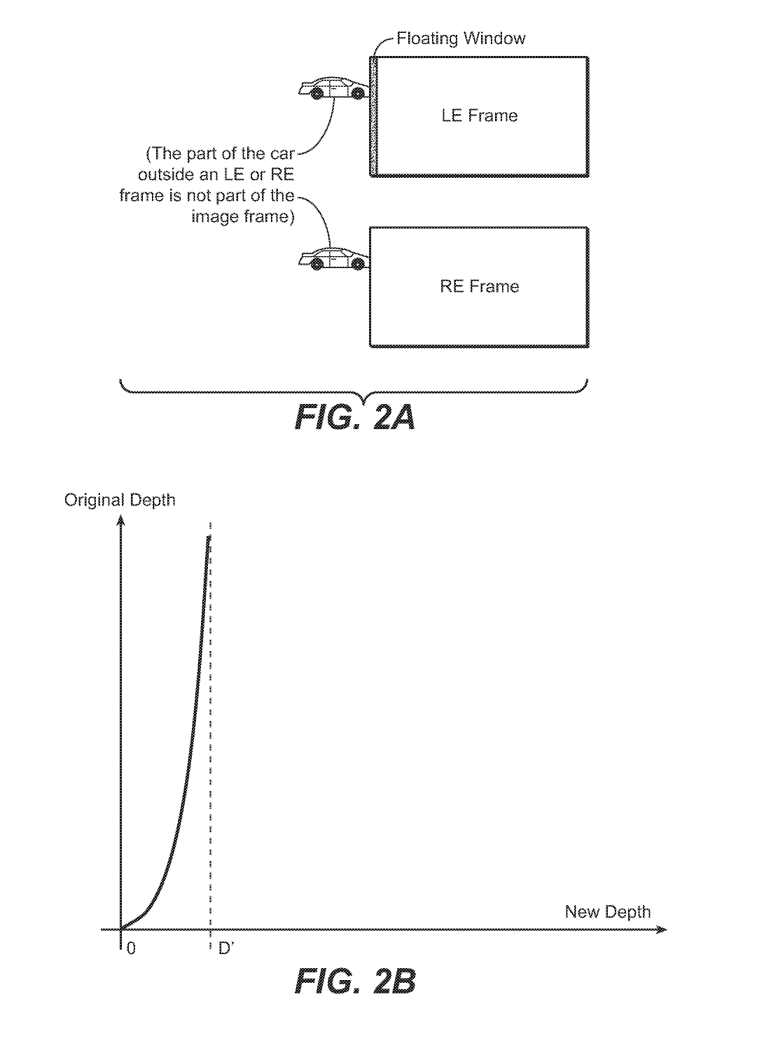

As illustrated in FIG. 2B, the original depth volume in a received pair of LE and RE frames can range from close to zero (e.g., 5 inches to a viewer, etc.) to close to infinity (e.g., asymptotically close to 30 feet to the viewer, etc.), whereas the new depth volume supported by a recipient 3D display system can be much compressed (e.g., asymptotically close to a relatively small finite depth D′ such as 30 inches, etc.).

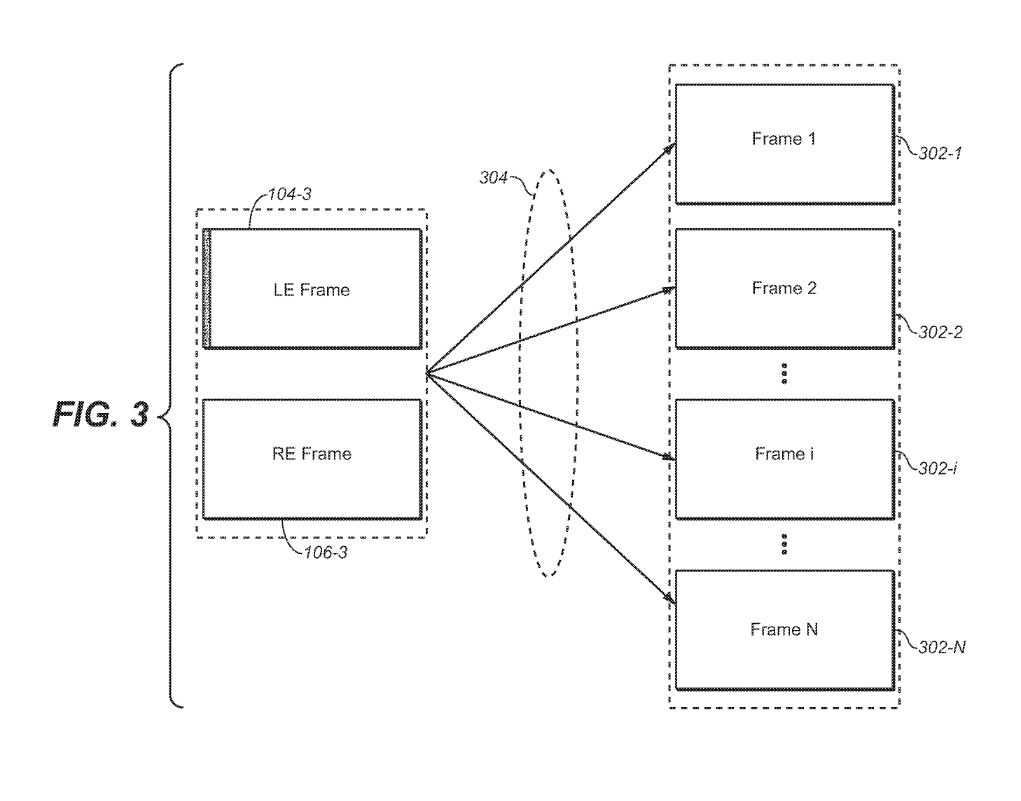

In some embodiments, different views other than those in a received pair of LE and RE frames are needed. As illustrated in FIG. 3, received LE and RE frames (104-1 and 106-1) are converted into a plurality of frames (302-1 through 302-N), where N is a positive integer greater than one (1). In embodiments in which the display system is a 3D autostereoscopic system, each frame in the plurality of frames is a different view of multiple views emitted by the 3D autostereoscopic system in a specific spatial cone; the multiple views are repeated in a plurality of spatial cones that include the specific cone.

In some embodiments, at least one frame in the plurality of frames (302-1 through 302-N) is derived from the received LE and RE frames (104-1 and 106-1) through one or more operations (304) that need to determine per pixel or per pixel block depth information in received LE and RE frames (104-1 and 106-1). Examples of these operations include, but are not limited to: interpolations, extrapolations, linear spatial transformations, non-linear spatial transformations, translations, rotations, depth compressions, depth expansions, volumetric compressions, volumetric expansions, etc.

In some embodiments, at least one frame in the plurality of frames (302-1 through 302-N) is a frame in the received LE and RE frames (104-1 and 106-1), or a frame derived through one or more operations (not shown) that need not to determine per pixel or per pixel block depth information in received LE and RE frames (104-1 and 106-1).

### 4. DETERMINING DEPTH INFORMATION BASED ON TEMPORAL INFORMATION

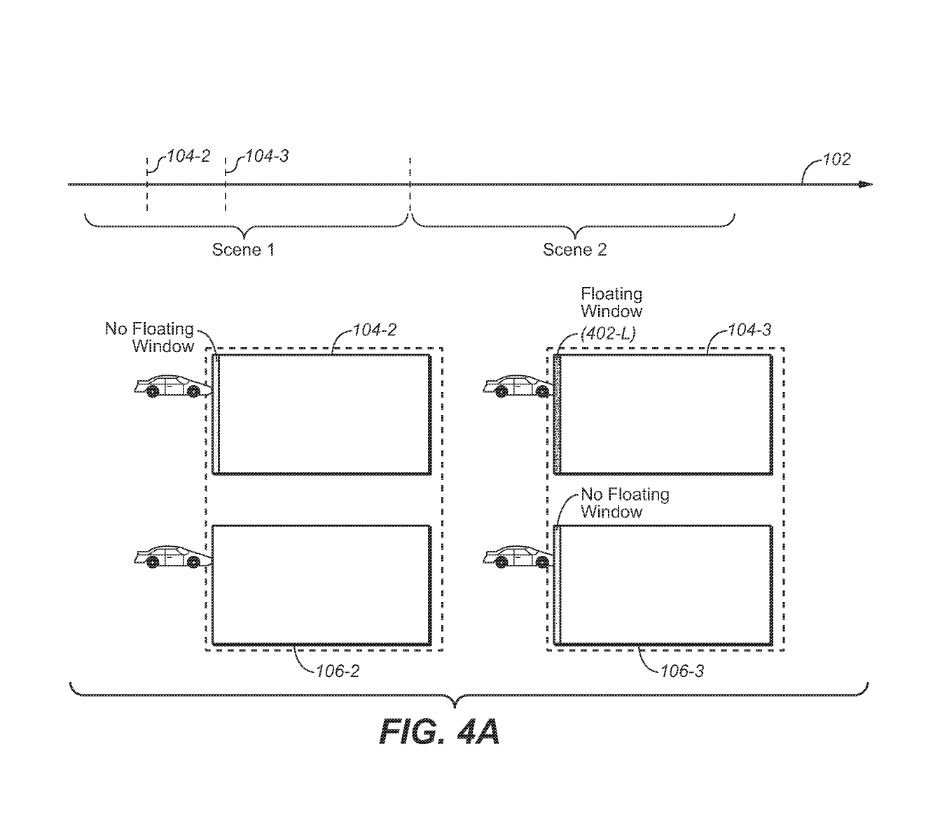

In a pair of LE and RE frames, one frame may have a floating window, while the other frame does not have a floating window. In an example as illustrated in FIG. 4A, in a scene, a car transits into a screen plane, for example, from the left. In a pair of LE and RE frames (104-3 and 106-3), the car is dismembered into a part in the screen plane, which is visible and the remaining part outside the screen plane, which is invisible. A floating window is placed in LE frame 104-3 while no floating window is placed in RE frame 106-3, which thus represents a full resolution image (e.g., as decoded/reconstructed from an input signal, etc.). In another pair of LE and RE frames (104-2 and 106-2) that precedes the pair of LE and RE frames (104-3 and 106-3), the car is not a part in the screen plane. Hence all the pixels (e.g., background pixels, a stationary object's pixels, etc.) that are inside the floating window (402-L) in LE frame 104-3 and that do not portray the car are the same as or substantially the same as the corresponding pixels in the same area of LE frame 104-2. If the scene is stationary, the pixels may be the same. If the scene is non-stationary, for example, involving camera panning, the pixels may be substantially the same depending on how much time elapses between LE frame 104-2 and LE frame 104-3. In the non-stationary case, motion estimation (e.g., based on analyzing similar or dissimilar color and/or luminance values and/or spatial sizes, etc.) can be used to correlate the pixels that are inside the floating window (402-L) in LE frame 104-3 and that do not portray the car with the corresponding pixels in LE frame 104-2. For the purpose of illustration only, a floating window is placed on a left or right edge of a frame in a pair of LE and RE frames. However, one or more floating windows may be placed at other positions of a frame. For example, a floating window may be placed at one or more extremities of a frame, positioned at one of left, right, bottom, and top edges of a frame, disposed away from any edge of a frame, etc. These and other positions of floating windows in a frame are within the scope of the invention.

For the purpose of illustration only, a floating window is depicted as a rectangular shape. However, a floating window may be of any regular (e.g., bar, trapezoid, etc.) or irregular shape in a 2D or 3D space. For example, a floating window may occupy any shape including that of a 3D object portrayed in a scene. The size and/or shape of a floating window may also dynamically change from frame to frame. These and other variations of sizes and/or shapes of floating windows are within the scope of the invention.

While a floating window may be placed in different positions of a frame, in some embodiments, specific positions of a floating window, such as relating to cutting the boundary of an image edge, may be used by a system as described herein to detect the floating window as opposed to large areas of dark black regions in an image, and thus to estimate depth information for pixels that are covered by the floating window.

For the purpose of illustration only, it has been described that depth information for pixels covered by a floating window in a sequence of LE and RE frames may be determined from frames of temporal neighbors to one or more frames that contain the floating window. However, for the purpose of the invention, floating windows may be present in any one of multiple views in a sequence of multi-view frames that may have frames of two or more perspectives (e.g., left eye 1, left eye 2, central, right eye 1, right eye 2, etc.) other than only LE and RE perspectives. Techniques as described herein can be used to recover depth information for pixels covered by a floating window in anyone of the multiple views in a sequence of multi-view frames. Particularly, a sequence of LE and RE frames as previously discussed may be considered as a specific example, a specific subset, etc., of a sequence of multi-view frames; operations similar to those that have been illustrated in the case of LE and RE frames may be performed to generate depth information in one or more of multiple views in a sequence of multi-view frames as received from an input signal based on frames of temporal neighbors to one or more frames containing the floating window.

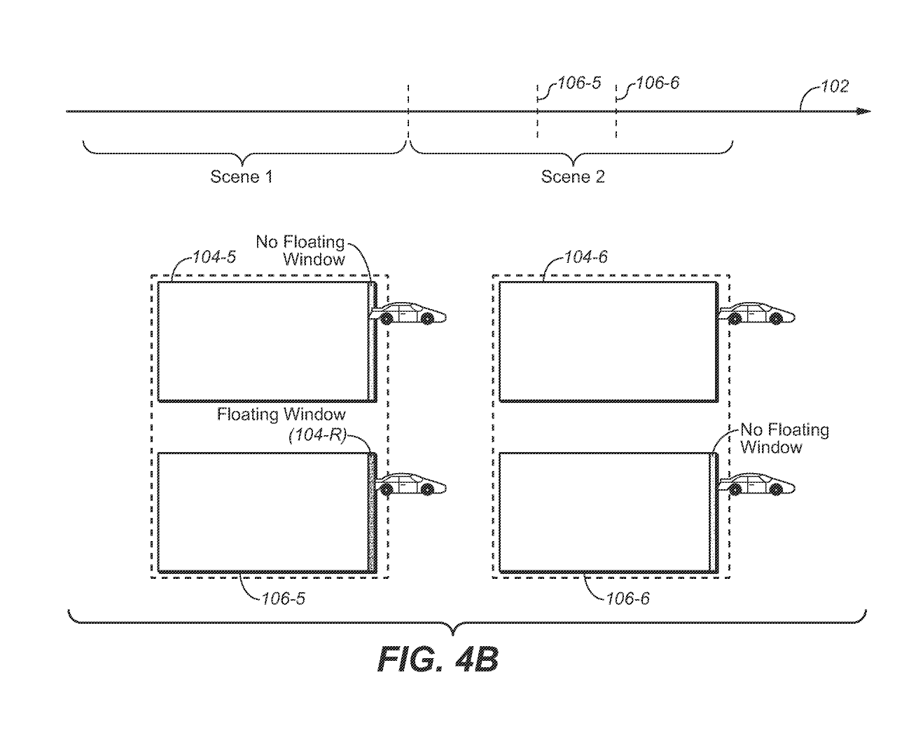

FIG. 5A illustrates an example process flow for determining depth information in 3D images. Additional reference will be made to FIG. 4A. The 3D images are represented by respective pairs of LE and RE frames received from a content source such as a 3D Blu-ray disc or one or more video bitstreams. A system comprising one or more computing devices is used to perform the process flow.

A sequence of 3D images (as illustrated in FIG. 4A) may comprise one or more scenes, each of which may comprise a subsequence of 3D images represented by respective pairs of LE and RE frames along a media time direction 102. For the purpose of illustration only, the system processes a sequence of pairs of LE and RE frames long the media time direction 102. In the present example, a floating window appears in the LE frame 104-3 but not in the LE frame 104-2, RE frame 106-2, and RE frame 106-3. Under techniques as described herein, pixels in the LE frame 104-2 may be used to recover some or all of the depth information lost in the pair of LE and RE frames (104-3 and 106-3) due to the presence of the floating window in LE frame 104-3. For the purpose of illustration only, only LE frames (104-2 and 104-3) are represented with the media time direction 102. However, it should be understood that there may exist corresponding RE frames (e.g., 106-2, 106-3, etc.) and other pairs of LE and RE frames interleaving, concurrently presenting, preceding, or following relative to the LE frames (104-2 and 104-3) along the media time direction 102.

Initially, in step 502, the system sets a variable representing a current scene to a particular starting value (e.g., 1). In step 504, the system resets one or more frame buffers to hold incoming LE and RE frames. In step 506, the system reads an image pair (or a pair of LE and RE frames) and buffers the received image pair with the frame buffers. In step 508, the system extracts depth information for a 3D image represented by the received image pair from the received image pair. The depth information can be extracted based on disparity information in the image pair. The depth information extracted in step 508 from the received image pair (e.g., 104-2 and 106-2) would be complete, if the received image pair (e.g., 104-2 and 106-2) had no floating window in either frame thereof. However, the depth information extracted in step 508 from the received image pair (e.g., 104-3 and 106-3) would be partial, if the received image pair (e.g., 104-3 and 106-3) has a floating window in one frame (e.g., 104-3) thereof.

In step 510, the system determines whether a floating window exists in a frame in the image pair. If the answer is yes (to whether a floating window exists in a frame in the image pair (e.g., 104-3 and 106-3)), the process flows goes to step 512, in which the system extracts depth information based on pixel information from one or more previous frames or one or more previous image pairs buffered by the system (e.g., 104-2, etc.). The system uses the depth information extracted from the one or more previous frames or image pairs to complement the depth information extracted from the current image pair.

On the other hand, if the answer is no (to whether a floating window exists in a frame in the image pair (e.g., 104-2 and 106-2)), the process flow goes to step 514, in which the system determines whether the image pair represents a new scene (e.g., scene 2 of FIG. 4A) that is different from the current scene (e.g., scene 1 of FIG. 4A).

If the answer is yes (to whether the image pair represents a new scene), the process flows goes to step 522, in which the system sets the new scene as the current scene (e.g., incrementing the variable representing a current scene by one, etc.) and from which the process flow continues until the system determines ending the processing (e.g., at the end of a video program, a user input command to stop the processing, etc.).

On the other hand, if the answer is no (to whether the image pair represents a new scene), the process flows goes to step 506, from which the process flow continues until the system determines ending the processing (e.g., at the end of a video program, a user input command to stop the processing, etc.).

In an example as illustrated in FIG. 4B, in a scene, a car transits out of a screen plane, for example, to the right. In a pair of LE and RE frames (104-5 and 106-5), the car is dismembered into a part in the screen plane, which is visible and the remaining part outside the screen plane, which is invisible. A floating window is placed in RE frame 106-5 while no floating window is placed in LE frame 104-5, which thus represents a full resolution image (e.g., as decoded/reconstructed from an input signal, etc.). In another pair of LE and RE frames (104-6 and 106-6) that follows the pair of LE and RE frames (104-5 and 106-5), the car is not a part in the screen plane. Hence all the pixels that are inside the floating window (402-R) in RE frame 106-5 and that do not portray the car may be the same as or substantially the same as the corresponding pixels in the same area of RE frame 106-6. If the scene is stationary, the pixels may be the same. If the scene is non-stationary, for example, involving camera panning, the pixels may be substantially the same depending on how much time elapses between RE frame 106-5 and RE frame 106-6. In the non-stationary case, motion estimation (e.g., based on analyzing correlated color and/or luminance values and/or spatial sizes, etc.) can be used to correlate the pixels that are inside the floating window (402-R) in RE frame 106-5 and that do not portray the car with the corresponding pixels in RE frame 106-6.

FIG. 5B illustrates another example process flow for determining depth information in 3D images. Additional reference will be made to FIG. 4B. The 3D images are represented by respective pairs of LE and RE frames received from a content source such as a 3D Blu-ray disc or one or more video bitstreams. A system comprising one or more computing devices is used to perform the process flow.

A sequence of 3D images (as illustrated in FIG. 4B, which may be the same sequence of 3D images in FIG. 4A) may comprise one or more scenes, each of which comprises a subsequence of 3D images represented by respective pairs of LE and RE frames along a media time direction 102. For the purpose of illustration only, the system processes a sequence of pairs of LE and RE frames long the media time direction 102. In the present example, a floating window appears in the RE frame 106-5 but not in the LE frame 104-5, LE frame 104-6, and RE frame 106-6. Under techniques as described herein, pixels in the LE frame 106-6 can be used to recover some or all of the depth information lost in the pair of LE and RE frames (104-5 and 106-5) due to the presence of the floating window in RE frame 106-5. For the purpose of illustration only, only RE frames (106-5 and 106-6) are represented with the media time direction 102. However, it should be understood that there may exist corresponding LE frames (e.g., 104-5, 104-6, etc.) and other pairs of LE and RE frames interleaving, concurrently presenting, preceding, or following relative to the RE frames (106-5 and 106-6) along the media time direction 102.

Initially, in step 522, the system sets a variable representing a current scene to a particular starting value (e.g., 1). In step 524, the system resets one or more frame buffers to hold incoming LE and RE frames. In step 526, the system receives a current image pair (or a current pair of LE and RE frames). In step 528, the system extracts depth information for a 3D image represented by the received image pair from the received image pair. The depth information may be extracted based on disparity information in the image pair. The depth information extracted in step 528 from the received image pair (e.g., 104-6 and 106-6) would be complete, if the received image pair (e.g., 104-6 and 106-6) had no floating window in either frame thereof. However, the depth information extracted in step 508 from the received image pair (e.g., 104-5 and 106-5) would be partial, if the received image pair (e.g., 104-5 and 106-5) has a floating window in one frame (e.g., 106-5) thereof.

In step 530, the system determines whether a floating window exists in a frame in the image pair. If the answer is yes (to whether a floating window exists in a frame in the image pair (e.g., 104-5 and 106-5)), the process flows goes to step 532, in which the system peeks or buffers one or more subsequent frames or subsequent image pairs. In step 534, the system extracts depth information based on pixel information from one or more subsequent frames or one or more subsequent image pairs buffered by the system (e.g., 106-6, etc.). The system uses the depth information extracted from the one or more subsequent frames or image pairs to complement the depth information extracted from the current image pair.

On the other hand, if the answer is no (to whether a floating window exists in a frame in the image pair (e.g., 104-6 and 106-6)), the process flows goes to step 536, in which the system determines whether the image pair represents a new scene (e.g., scene 2 of FIG. 4B) different from the current scene (e.g., scene 1 of FIG. 4B).

If the answer is yes (to whether the image pair represents a new scene), the process flow goes to step 522, in which the system sets the new scene as the current scene (e.g., incrementing the variable representing a current scene by one, etc.) and from which the process flow continues until the system determines ending the processing (e.g., at the end of a video program, a user input command to stop the processing, etc.).

On the other hand, if the answer is no (to whether the image pair represents a new scene), the process flows goes to step 526, from which the process flow continues until the system determines ending the processing (e.g., at the end of a video program, a user input command to stop the processing, etc.).

It should be noted that the example process flows are provided for illustration purposes only. For example, an object may transit out of a screen plane with a floating window in one or more LE frames, instead of in one or more RE frames as illustrated in FIG. 4B. Similarly, an object may transit into a screen plane with a floating window in one or more RE frames, instead of in one or more LE frames as illustrated in FIG. 4A. In some embodiments, the process flows as illustrated in FIG. 5A and FIG. 5B may be combined, altered, or optimized in one or more specific implementations. For example, a plurality of pairs of image frames may be read in a single step such as step 506 of FIG. 5A or step 526 of FIG. 5B. As a result, the need to perform repeated reading or buffering may be lessened. Similarly, when subsequent image pairs have already been read, for example, in step 532 of FIG. 5B, step 526 may directly receive a current image pair from a frame buffer holding the already read image pairs. In some embodiments, instead of buffering previous and/or subsequent frames or pairs of LE and RE frames, depth information derived from the previous and/or subsequent frames or pairs of LE and RE frames may be buffered instead. In various embodiments, these and other variations may be used to recover/reconstruct/approximate depth information of a current image pair from previous frames or image pairs, from subsequent frames or image pairs, or from both previous and subsequent frames or image pairs.

### 5. MOTION ESTIMATION

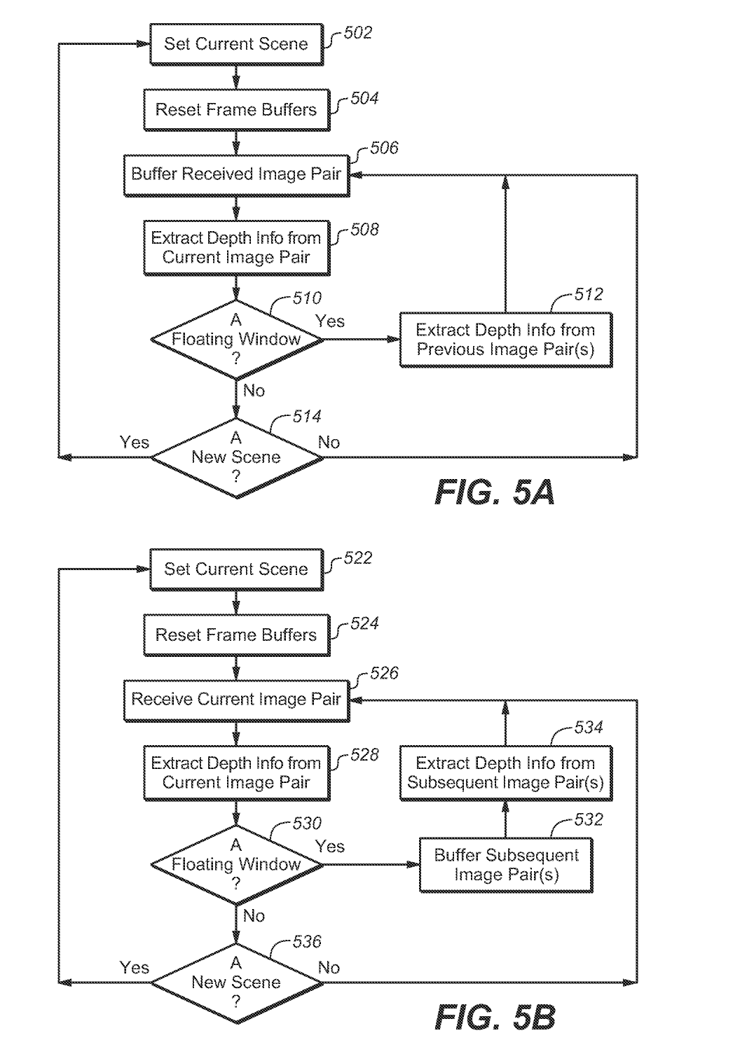

In some embodiments, motion analyses may be performed as a part of a process flow such as illustrated in FIG. 5A and FIG. 5B. Motion estimation can be generated for a pixel cluster that represents an object or a visual feature (e.g., a moving car) based on the represented content in a series of (e.g., only LE, only RE, both LE and RE, single view, multi-view, etc.) image frames. As illustrated in FIG. 6, a motion vector 604 is generated for a moving car (or a pixel cluster representing the moving car) based on analyzing the visual content in a series of image frames (602-1, 602-2, 602-3, etc.). While a part of the car is covered by a floating window in 602-3, results of motion analyses performed on the series of image frames (602-1, 602-2, 602-3, etc.), such as the motion vector 604, can be used to predict or reconstruct the pixel values and/or depth information for the part of the car covered in the floating window.

A 3D display system can be configured to render one or more views that are different from either LE or RE view as represented in a received pair of LE and RE frames. The one or more views may include (e.g., 2, 3, etc.) views between an adult viewer's typical inter-pupil distance (e.g., 6.3 cm) at a certain viewing distance so that children can also view the 3D images properly. The one or more views may include (e.g., 28, etc.) views in a spatial cone so that a viewer is not constrained to view 3D images from a fixed position and that the viewer can perceive expected viewpoint changes to the 3D images when the viewer moves around. For views that are different from either LE or RE view as represented in a received pair of LE and RE frames, since a viewer is not viewing from implied angles of the received pair of LE and RE frames, the floating window may not be needed or may need to be resized. Indeed, small floating windows may not present significant problems with certain 3D display systems if the floating windows are not visually noticeable. However, for other 3D display systems, for example, with short viewing distances or of large screen planes, visual artifacts related to the presence of floating windows may become rather noticeable as human vision is attuned to notice moving objects, flicking, visual variations and visible abnormalities especially in peripheral vision. Accordingly, in some embodiments, the predicted pixel values and/or depth information from motion analyses can be used to reconstruct or make visible certain objects, visual features, backgrounds (e.g., moving as a result of camera panning, etc.)—which otherwise might be covered by floating windows—in certain views in these 3D display systems, thereby providing a better 3D viewing experience.

For the purpose of illustration only, 3D images from an input signal, a file, a server, etc., have been described as being represented by respective received pairs of LE and RE frames. However, techniques as described herein can be similarly applied to 3D images that are represented by respective received sets of multi-view frames.

### 6. EXAMPLE SYSTEM CONFIGURATIONS

Techniques as described herein may be implemented on the video decoder side, the video encoder side, in part on the video decoder side and in part on the video encoder side, etc.

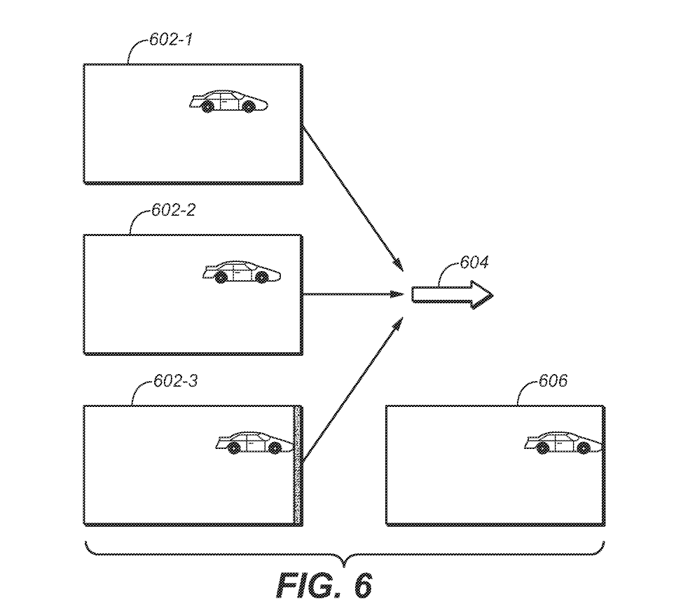

As illustrated in FIG. 7A, a video decoder 702 can be a part of a display system 700 or in close proximity (e.g., in the same box, in a connected set-top box, in the same living room, etc.) to the display system (700). In some embodiments, the video decoder (702) can be a part of display control logic 706 of the display system (700). The video decoder (702) receives/decodes, from a 3D content source 704 (e.g., video file, a video signal, etc.), a sequence of 3D images (e.g., as illustrated in FIG. 4A and FIG. 4B) represented by a sequence of respective pairs of LE and RE frames. The LE and RE frames may be received from the 3D content source (704), for example, in a 3D Blu-ray format. Some frames in the received pairs of LE and RE frames contain floating windows. The video decoder generates complete or substantially complete depth information for some or all the pairs of LE and RE frames in the sequence including those pairs of LE and RE frames that contain the floating windows. The depth information can be used in display operations (including generating different perspectives, different depth ranges, etc.) for rendering 3D images on a screen plane 708 of the display system (700). The 3D images as rendered may be represented by image frames converted or generated based on the LE and RE frames received from the 3D content source (704).

Additionally, optionally, or alternatively, techniques as described herein may be implemented on the video encoder side. As illustrated in FIG. 7B, a video encoder 712 may be remote to a display system (e.g., 700) or otherwise may not be a part of the display system (700). In some embodiments, the video encoder (712) can be configured to receive/decode, from a 3D content source (e.g., video file, a video signal, etc.), a sequence of 3D images (e.g., as illustrated in FIG. 4A and FIG. 4B) represented by a sequence of respective pairs of LE and RE frames. The LE and RE frames may be received from the 3D content source, for example, in a 3D format adapted for cinema. Some frames in the received pairs of LE and RE frames contain floating windows. The video encoder (712) generates complete or substantially complete depth information for some or all the pairs of LE and RE frames in the sequence including those pairs of LE and RE frames that contain the floating windows. The video encoder (712) encodes the depth information with a sequence of 3D images corresponding to the received sequence of pairs of LE and RE frames into an output 714 (e.g., video file, video signal, video bitstream, etc.) to be provided to a recipient device. The output (714) may be in the same or a different 3D format (e.g., a 3D Blu-ray format) as the format used by the received pairs of LE and RE frames.

Whether generated or received by a video decoder, the depth information can be used by the video decoder and/or by a display system containing or operating in conjunction with the video decoder to perform one or more operations including those that require determining the depth information for pixels that are affected by floating windows.

In some embodiments, depth information for a 3D image or a corresponding pair of LE and RE frames is represented with a depth map. In some embodiments, such a depth map may cover an area that exceeds the area of a corresponding pair of LE and RE frames as decoded or constructed from the released version of 3D images. The extra depth information in such a depth map can be derived from previous or subsequent pairs of LE and RE frames through one or more operations including but not limited to: motion analyses, color analyses, luminance analyses, etc. The extra depth information can be used to reduce artifacts, as well as concealment thereof, both at one or more edges of a screen plane and where floating windows are used. The oversized depth maps can be dynamically adjustable so as to apply to image areas that may benefit from the higher amount of depth related information. To achieve the mappings more efficiently (and without “breaking the bank” in relation to computational overhead) however, a larger depth map with pixel level accuracy is not required in some embodiments. For example, a simple fractional/percentage expansion in an image area in a horizontal direction and/or in a vertical direction can be used to subsample the larger depth map into a depth map that has the same size (e.g., same number of pixels, same number of pixel blocks, etc.) as a LE or RE frame. Bandwidth economy may be achieved with subsampling in the horizontal direction and/or in the vertical direction because the subsampled depth map may be scaled up and then cropped to generate depth information for an image area equaling or comparable with an image area of a LE or RE frame. Thus, in some embodiments, pixel-level accuracy may not be required to recover or reconstruct depth information that is lost due to the presence of floating windows.

3D images as described herein may be provided by a 3D content source, a 3D video encoder, etc., in a variety of ways including over-the-air broadcast, cable signals, satellite signals, internet download, USB signals, Firewire signals, High-Definition Multimedia Interface (HDMI) video signals, wireless network access, wire-based network access, video files or signals through devices such as one or more set-top boxes, servers, storage mediums, etc.

### 7. PROCESS FLOWS

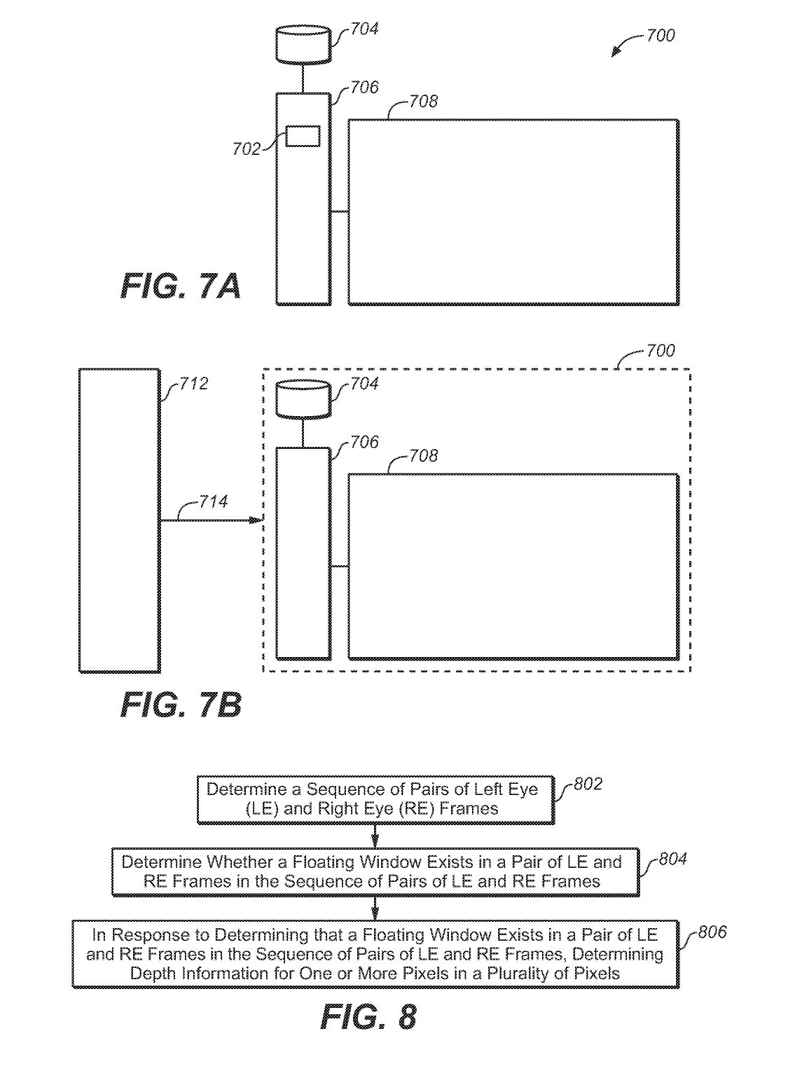

FIG. 8 illustrates a process flow according to an example embodiment of the invention. In some example embodiments, a 3D system (such as illustrated in FIG. 7A and FIG. 7B) comprising one or more computing devices or components may perform this process flow. In block 802, the system receiving a sequence of pairs of LE and RE frames.

In block 804, the system determines whether a floating window exists in a frame in a pair of LE and RE frames in the sequence of pairs of LE and RE frames. In block 806, in response to determining that a floating window exists in a frame in a pair of LE and RE frames in the sequence of pairs of LE and RE frames, the system determines depth information for one or more pixels in a plurality of pixels. Here, the plurality of pixels is in a portion of the frame covered by the floating window. The depth information for the one or more pixels in the plurality of pixels in the portion of the frame covered by the floating window is generated based on depth information extracted from one or more frames in one or more pairs of LE and RE frames in the sequence of pairs of LE and RE frames that are either previous or subsequent to the pair of LE and RE frames.

In some embodiments, each pair of LE and RE frames represents a respective 3D image of a sequence of 3D images represented by the sequence of LE and RE frames. The sequence of pairs of LE and RE frames is included in a released version of 3D content.

In some embodiments, the pair of LE and RE frames in the sequence of LE and RE frames is a subset of frames in a set of multi-view input frames that represent a 3D image.

In some embodiments, an estimated motion of a cluster of pixels in a series of frames is used to predict values for one or more pixels in the plurality of pixels in the frame. The frame may be one of the frames immediately preceding the series of frames, frames immediately following the series of frames, or frames in the series of frames.

In some embodiments, the system is configured to generate, based at least in part on the depth information of the one or more pixels in the portion of the frame covered by the floating window, a plurality of output frames to represent an output 3D image that corresponds to an input 3D image represented by the pair of LE and RE frames that include the frame partially covered by the floating window.

In some embodiments, the system is further configured to perform one or more operations relative to the pair of LE and RE frames, wherein the one or more operations includes at least one of: interpolations, extrapolations, linear spatial transformations, non-linear spatial transformations, translations, rotations, depth compressions, depth expansions, volumetric compressions, or volumetric expansions.

In some embodiments, the depth information for the one or more pixels in the plurality of pixels in the portion of the frame covered by the floating window is represented in a depth map for the pair of LE and RE frames. The depth map may cover an area that exceeds an area represented by pixels of the pair of LE and RE frames. The depth map may comprise depth information at one of same resolutions or different resolutions of LE and RE frames in the pair of LE and RE frames. In some embodiments, the system is further configured to output the depth map with a set of frames corresponding to the pair of LE and RE frames, wherein the set of frames may be the pair of LE and RE frames or may represent an output 3D image that corresponds to a 3D image represented by the pair of LE and RE frames.

In some embodiments, an apparatus comprising a processor and configured to perform the method as described herein. In some embodiments, a computer readable storage medium, storing software instructions, which when executed by one or more processors cause performance of the method as described herein. In some embodiments, a computing device comprising one or more processors and one or more storage media storing a set of instructions which, when executed by the one or more processors, cause performance of the method as described herein.

### 8. IMPLEMENTATION MECHANISMS—HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

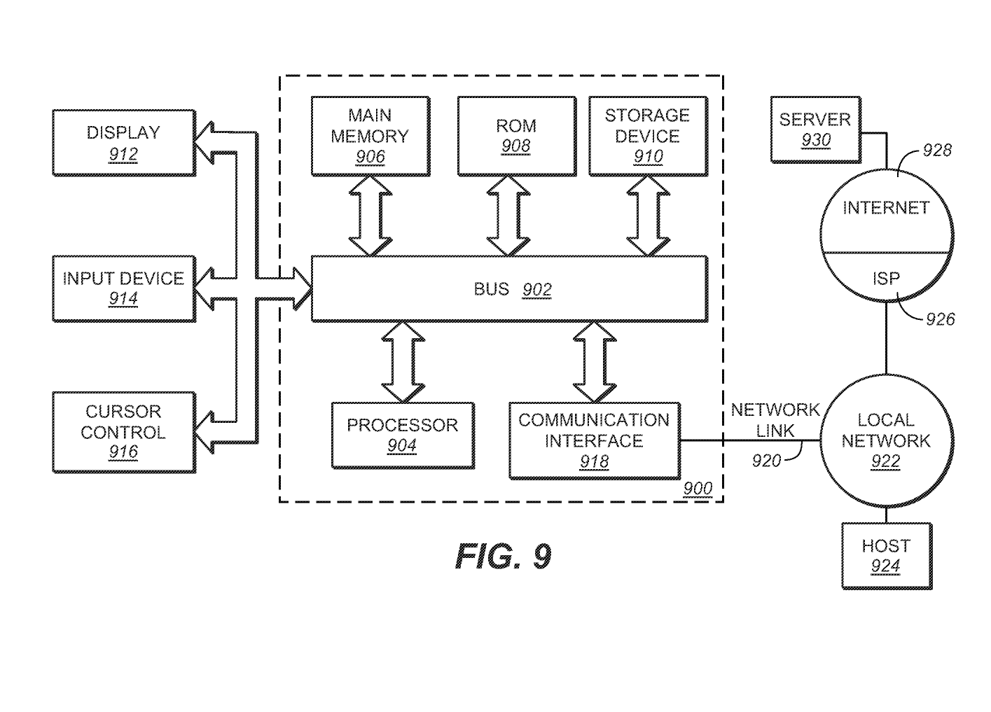

For example, FIG. 9 is a block diagram that illustrates a computer system 900 upon which an embodiment of the invention may be implemented. Computer system 900 includes a bus 902 or other communication mechanism for communicating information, and a hardware processor 904 coupled with bus 902 for processing information. Hardware processor 904 may be, for example, a general purpose microprocessor.

Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Such instructions, when stored in non-transitory storage media accessible to processor 904, render computer system 900 into a special-purpose machine that is customized to perform the operations specified in the instructions.

Computer system 900 further includes a read only memory (ROM) 908 or other static storage device coupled to bus 902 for storing static information and instructions for processor 904. A storage device 910, such as a magnetic disk or optical disk, is provided and coupled to bus 902 for storing information and instructions.

Computer system 900 may be coupled via bus 902 to a display 912, such as a liquid crystal display, for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

Computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques as described herein are performed by computer system 900 in response to processor 904 executing one or more sequences of one or more instructions contained in main memory 906. Such instructions may be read into main memory 906 from another storage medium, such as storage device 910. Execution of the sequences of instructions contained in main memory 906 causes processor 904 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 910. Volatile media includes dynamic memory, such as main memory 906. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor 904 for execution. For example, the instructions may initially be carried on a magnetic disk or solid state drive of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918.

The received code may be executed by processor 904 as it is received, and/or stored in storage device 910, or other non-volatile storage for later execution.

### 9. EQUIVALENTS, EXTENSIONS, ALTERNATIVES AND MISCELLANEOUS

In the foregoing specification, possible embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method, comprising:
determining a sequence of pairs of left eye (LE) and right eye (RE) frames;
determining whether a frame comprising a floating window exists in a pair of LE and RE frames in the sequence of pairs of LE and RE frames; and
in response to determining that a frame comprising a floating window exists in a pair of LE and RE frames in the sequence of pairs of LE and RE frames, determining depth information for one or more pixels in a plurality of pixels in a portion of the frame covered by the floating window;
wherein the depth information is extracted from one or more frames in one or more pairs of LE and RE frames in the sequence of pairs of LE and RE frames either prior or subsequent in the sequence to the pair of LE and RE frames, wherein an estimated motion of a cluster of pixels in a series of frames is used to predict values for one or more pixels in the plurality of pixels in the frame, and wherein the frame is one of frames immediately preceding the series of frames, frames immediately following the series of frames, or frames in the series of frames.

2. The method as recited in claim 1, wherein each pair of LE and RE frames represents a respective 3D image of a sequence of 3D images represented by the sequence of LE and RE frames.

3. The method as recited in claim 1, wherein the sequence of pairs of LE and RE frames is included in a released version of 3D content.

4. The method as recited in claim 1, wherein the pair of LE and RE frames in the sequence of LE and RE frames is a subset of frames, in a set of multi-view input frames that represent a 3D image.

5. (canceled)

6. The method as recited in claim 1, further comprising:
generating, based at least in part on the depth information of the one or more pixels in the portion of the frame covered by the floating window, a plurality of output frames to represent an output 3D image that corresponds to an input 3D image represented by the pair of LE and RE frames that include the frame partially covered by the floating window.

7. The method as recited in claim 1, further comprising performing one or more operations relative to the pair of LE and RE frames, wherein the one or more operations includes at least one of: interpolations, extrapolations, linear spatial transformations, non-linear spatial transformations, translations, rotations, depth compressions, depth expansions, volumetric compressions, or volumetric expansions.

8. The method as recited in claim 1, wherein the method is performed by one or more computing devices including at least one of: video encoders, video decoders, art studio systems, cinema systems, display systems, handheld devices, tablet computers, theater systems, outdoor displays, game machines, televisions, laptop computers, netbook computers, cellular radiotelephones, electronic book readers, point of sale terminals, desktop computers, computer workstations, computer kiosks, or personal digital assistant.

9. The method as recited in claim 1, wherein the depth information for the one or more pixels in the plurality of pixels in the portion of the frame covered by the floating window is represented in a depth map for the pair of LE and RE frames.

10. The method as recited in claim 9, wherein the depth map covers an area that exceeds an area represented by pixels of the pair of LE and RE frames.

11. The method as recited in claim 9, wherein the depth map comprises depth information at one of same resolutions or different resolutions of LE and RE frames in the pair of LE and RE frames.

12. The method as recited in claim 9, further comprising outputting the depth map with a set of frames corresponding to the pair of LE and RE frames, wherein the set of frames is either the pair of LE and RE frames or represents an output 3D image that corresponds to a 3D image represented by the pair of LE and RE frames.

13. The method as recited in claim 1, wherein the pair of LE and RE frames and the one or more pairs of LE and RE frames are from a same scene in the sequence of pairs of LE and RE frames.

14. The method as recited in claim 1, wherein the sequence is in a display order.

15. The method as recited in claim 1, wherein the sequence of pairs of LE and RE frames represents a proper subset of a sequence of multi-view frames.

16. The method as recited in claim 1, wherein the floating window is one of regular shapes, irregular shapes, or shapes of one or more objects.

17. A method for rendering 3D image, the method comprising:
determining a sequence of pairs of left eye (LE) and right eye (RE) frames; and
determining depth information for one or more pixels altered by a floating window in a frame in the sequence of pairs of LE and RE frames;
wherein determining depth information includes generating the depth information based on depth information extracted from one or more frames either prior or subsequent in the sequence to the floating window.

18. The method of claim 17 wherein the floating window exists in only one frame in a pair of LE and RE frames.

19. An apparatus comprising a processor and configured to perform the method recited in claim 1.

20. A non-transitory computer readable storage medium, storing software instructions, which when executed by one or more processors cause performance of the method recited in claim 1.

21. A computing device comprising one or more processors and one or more storage media storing a set of instructions which, when executed by the one or more processors, cause performance of the method recited in claim 1.
